(19) United States
(12) Patent Application Publication
(10) Pub. No.: US 2019/0139054 A1
(43) Pub. Date: May 9, 2019

(54) SYSTEM AND METHOD FOR MAPPING TICKETS BETWEEN CUSTOMER-FACING AGENTS, SPECIALIZED AGENTS AND AGENT GROUPS

(71) Applicant: Freshworks Inc., San Bruno, CA (US)

(72) Inventors: Rathnagirish Mathrubootham, Chennai (IN); Arvind S. Ganesan, Chennai (IN); Arvind Ravindran, Chennai (IN); Divya Dhanasekar, Chennai (IN); Bharath Balasubramanian, Chennai (IN); Vijaybabu Siva, Chennai (IN)

(73) Assignee: Freshworks Inc.

(21) Appl. No.: 15/907,277

(22) Filed: Feb. 27, 2018

(30) Foreign Application Priority Data
Nov. 6, 2017 (IN) 201741039403

(51) Int. Cl. G06Q 30/00

(52) U.S. Cl. CPC G06Q 30/016

(57) ABSTRACT

A computer-implemented process for improving tracking and visibility of a ticket may include changing a status of a ticket, allowing ownership of the ticket to be shared with an internal agent. The process may also include depending on the changed status, an internal group mapped to the ticket is selected from a list of available internal groups, and selecting an available internal agent from a list of available agents within the internal group. The process may further include updating the ticket such that ownership of the ticket is shared between the customer-facing agent and the internal agent.

### CROSS-REFERENCE TO RELATED APPLICATION

This application claims the benefit of, and priority to, Indian Application Serial No. 201741039403, filed on Nov. 6, 2017. The subject matter thereof is hereby incorporated herein by reference in its entirety.

### FIELD

The present invention relates to sharing tickets, and more particularly, to mapping tickets such that ticket ownership may be shared between a customer-facing agent, specialized agents, and agent groups.

### BACKGROUND

In the customer support industry, businesses use logging and tracking software (“helpdesks”) to allow businesses to register, respond to, and resolve issues faced by their customers. These businesses typically have a set of employees (“agents”) that log into the helpdesk and resolve incoming issues (“tickets”). To facilitate an organized approach, agents are logically aggregated into “teams” and/or “groups” in the helpdesk, and each team or agent is dedicated to resolving specific types of issues.

While resolving tickets, it is not uncommon for a customer-facing agent to encounter issues that requires the customer-facing agent to seek assistance from a subject matter expert. For purposes of explanation, the subject matter expert may be known as the internal or specialized agent. In one example, the customer-facing agent may require expertise from multiple teams, such as procurement department, finance department, legal department, etc., in the organization before a solution can be found. When this occurs, more often than not, the ticket goes through many rounds and is assigned to different groups that need to work on the issue before the issue can be resolved. A workflow like this precludes the customer-facing agent from looking into the progress made on solving the issue. Simply put, the customer-facing agent may be in the dark until a solution is reached and the ticket is assigned back to the customer-facing agent. In fact, if the ticket is assigned to a group whose scope does not include the customer-facing agent, the ticket becomes inaccessible to the customer-facing agent. This means, if the customer were to reach out to the customer-facing agent, he or she would have little to no idea regarding the status of the solution.

Let's use an e-commerce company and the work flow shown in FIG. 1 as an example. In this example, when a customer 102 raises an issue about a defective product and requests a replacement, the first agent (or “customer-facing agent”) 104 is not the one to solve the problem. First agent 104 would change the status to ‘Waiting on Supplies’ and reassign the ticket to Supplies team 106. Supplies team 106 may check with for availability of the replacement. During this time, neither customer 102 nor first agent 104 will have an idea as to the availability of the replacement.

Once Supplies team 106 gives the okay for a replacement to first agent 104, first agent 104 may then change his or her status to ‘Assigned to Replacements’ and the ticket is assigned to Replacements team 108. Since the ticket is now owned by or assigned to Replacements team 108, neither customer 102 nor first agent 104 know the status of the replacement, i.e., when to expect shipment or delivery. Once the replacement is sent, the ticket is assigned back to first agent 104 so that he or she can let the customer know that the replacement is sent.

Simply put, under the conventional model shown in FIG. 1, if customer 102 responds at any time during these transitions, first (or the customer-facing) agent 104 cannot respond to the inquiry since the ticket has been temporality assigned to Supplies team 106 or Replacement team 108. This results in first agent 104 lacking visibility into the status as soon as the ticket has been assigned to a specialized group within the company.

It should be noted, however, that issues with ticket visibility are not limited to replacement products, but extend to issues such as “how to resolve . . . ”, “help me with . . . ”, “debugging”, etc. The ticket visibility issue is not only inefficient, but is also time consuming and lacks visibility. For example, the current work flow of FIG. 1 is inefficient in so far as the tickets have to bounce back and forth between various agents, and if a customer replies when a ticket is not in the scope of the customer-facing agent, the customer-facing agent will not be able to reply to the customer. Further, the customer-facing agents, including the specialized agents, have to wait for other agents to get back to them, since there is no way to follow-up on a ticket once the ticket is reassigned. Moreover, the customer-facing agents lack ticket visibility, and do not have any context into the progress of the ticket. Also, the ticket is inaccessible to the customer-facing agent as soon as the ticket is assigned to the specialized agent.

Thus, an alternative method of providing and improving visibility of a ticket may be beneficial.

### SUMMARY

Certain embodiments of the present invention may provide solutions to the problems and needs in the art that have not yet been fully identified, appreciated, or solved by current systems that customer support systems. For example, in some embodiments, the present invention generally pertains to a system and process for improving the visibility of the customer-facing agent over the ticket and improving the ability to share data (e.g., status of the ticket) between the customer-facing agent and one or more specialized agents.

In an embodiment, a computer-implemented process for improving tracking and visibility of a ticket may include changing a status of a ticket, allowing ownership of the ticket to be shared with an internal agent. The process may also include depending on the changed status, selecting an internal group mapped to the ticket from a list of available internal groups, and selecting an available internal agent from a list of available agents within the internal group. The process may further include updating the ticket such that ownership of the ticket is shared between the customer-facing agent and the internal agent.

In another embodiment, an apparatus may include at least one processor and memory comprising a set of instructions. The set of instructions, with the at least one processor, are configured to cause the apparatus to change a status of a ticket, allowing ownership of the ticket to be shared with an internal agent. Depending on the changed status, the set of instructions, with the at least one processor, are further configured to cause the apparatus to select an internal group mapped to the ticket from a list of available internal groups. The set of instructions, with the at least one processor, are further configured to cause the apparatus to select an available internal agent from a list of available agents within the internal group, and update the ticket such that ownership of the ticket is shared between the customer-facing agent and the internal agent.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is related art illustrating a process for opening and resolving a ticket.

FIG. 2 illustrates a work flow diagram improving visibility of a ticket for customer-facing agent 204, according to an embodiment of the present invention.

FIG. 3 is a network diagram for sharing ownership of a ticket, according to an embodiment of the present invention.

FIG. 4 is a flow diagram illustrating a process for sharing ownership of a ticket, according to an embodiment of the present invention.

FIG. 5 is a flow diagram illustrating a process for updating the ticket, according to an embodiment of the present invention.

FIG. 6 is a block diagram illustrating a computing system allowing a customer-facing agent to assigning the ticket improving ticket status visibility, according to one embodiment of the present invention.

### DETAILED DESCRIPTION OF THE EMBODIMENTS

In some embodiments, by sharing the ownership of a ticket, a customer-facing agent is provided with improved visibility into the ticket even when the ticket is assigned to an internal agent (or specialized agent). For example, the ticket may be shared by the customer-facing agent and one or more internal agents. Thus, some embodiments tie the customer-facing agent with the ticket no matter how many times the ticket is assigned to one or more internal agents.

It should be appreciated that agents are part of various groups. For example, the customer-facing agents may be part of the support group and the internal agents may be part of one of the internal groups. For example, a debugger may be part of the debugger group, a supply agent may be part of the supply group, a replacement agent may be party of the replacement group, and so on. It should be noted that the customer-facing agents and the internal agents are not part of the same group, and in some cases, internal agents may be part of different internal groups.

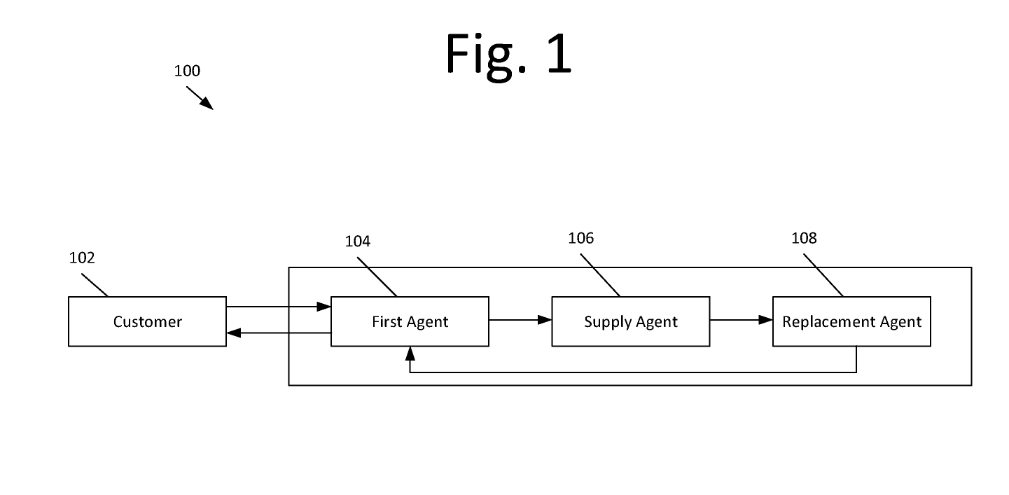

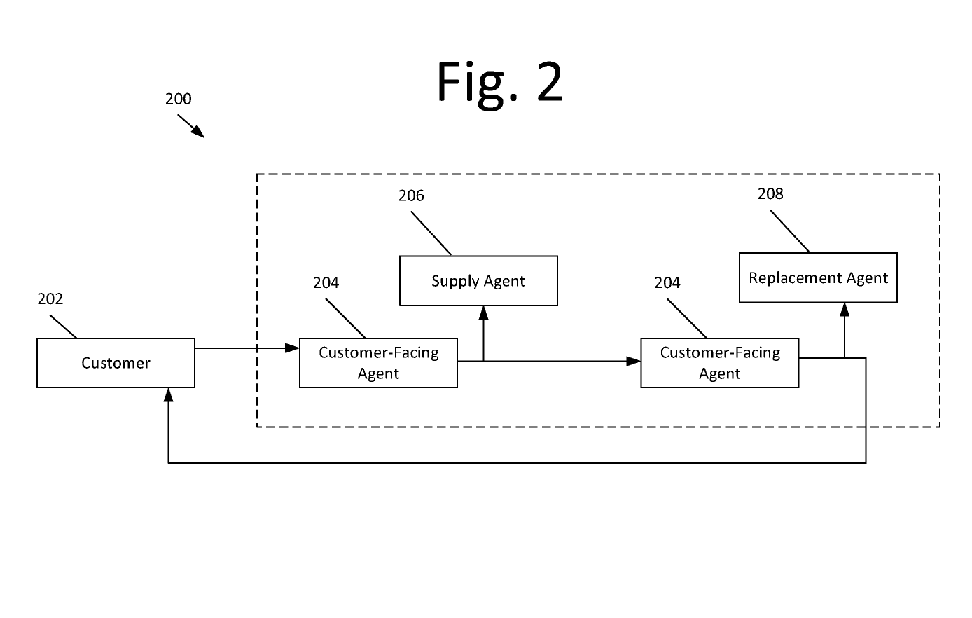

To resolve the issues presented in the work flow shown in FIG. 1, FIG. 2 illustrates a work flow diagram 200 improving visibility of a ticket for customer-facing agent 204, according to an embodiment of the present invention. In this example, customer 202 may raise an issue regarding a product, and request a ticket to be opened with customer-facing agent 204, for example. In response, customer-facing agent 204 may check for the availability by looping supplies agent 206 (specialize or internal agent) in with the ticket. By looping supplies agent 206 into the ticket, customer-facing agent 204 remains the primary agent and the supplies agent 206 is the secondary agent. This gives customer-facing agent 204 the ability to check the status of the ticket while supplies agent 206 is looking for the replacement product. This also allows the customer-facing agent 204 to give continuous updates to customer 202 regarding the ticket status.

When the supplies agent 206 notifies customer-facing agent 204 that a replacement product is available, customer-facing agent 204 may update the status of the ticket, removing supplies agent 206 from the ticket and looping in the next internal agent (e.g., replacement agent 208) to the ticket. It should be noted that supplies agent 206 and replacement agent 208 may be part of different groups. This allows customer-facing agent 204 to remain the primary agent over the ticket no matter how many times internal agents are removed and looped into the ticket, giving customer-facing agent 204 access to the ticket.

Furthermore, in certain embodiments, the internal group may have all the options of a customer-facing agent, and may further share the status of the ticket. Thus, depending on the embodiment, when a customer checks the status of the ticket, the customer-facing agent and/or the specialized agent may update the customer.

Each loop that is used may be assigned to a status. For example, when a ticket is open and waiting for a response from a supplies team, the status of the ticket is ‘waiting for a response from supplies team’. Similarly, when waiting for a response from replacement team, the status of the ticket is ‘waiting for a response from replacement team’. The status of the ticket may indicate where the ticket is in the work flow.

Because the transition flow is mapped to the internal group, such as replacement team in this example, the only agents that may be looped into a particular ticket may be those that are part of the internal group. Once the ticket with the internal group is resolved, the internal group sets the ticket to open (or some transition state). This results in the internal group associated with the ticket being knocked off or removed from the ticket.

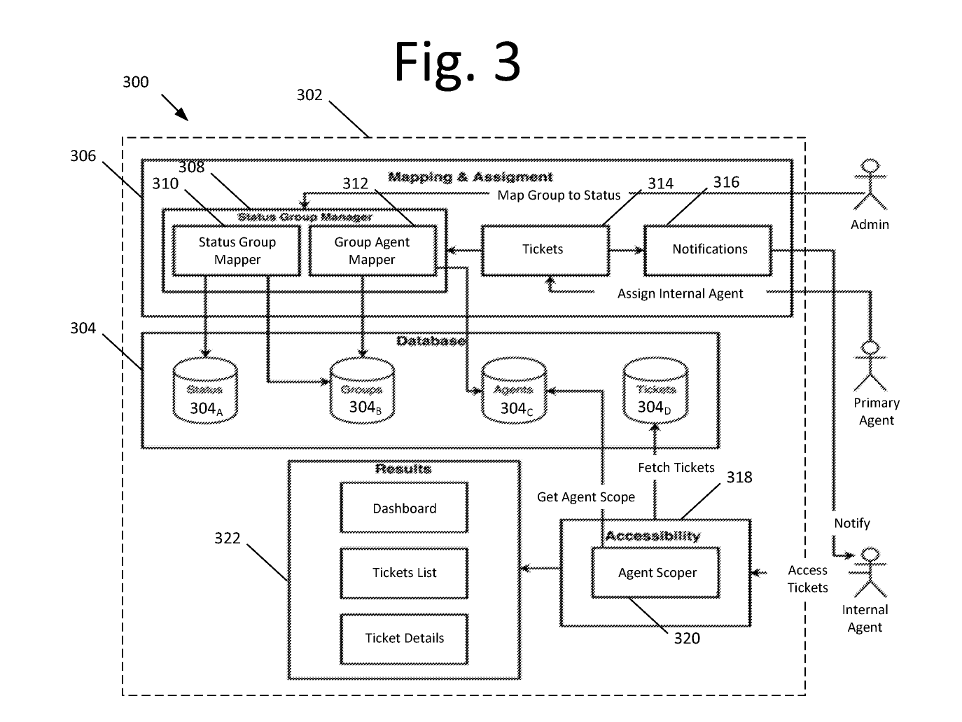

FIG. 3 is a network diagram 300 for sharing ownership of a ticket, according to an embodiment of the present invention. In this embodiment, an administrator, a primary (or customer-facing) agent, and an internal agent may access central server 302. Central server 302 may include a database 304 and multiple modules such as mapping and assignment database 306, accessibility module 320, and results module 322.

For the customer-facing agent to share ownership of, or for the internal (or specialized) agent to access, a ticket, the administrator initially maps one or more statuses to one or more internal groups. In some embodiments, each status presented with a ticket may be mapped to an internal group. For example, if a ticket is in a certain status (e.g., status indicating transition phase the issue is in), then certain groups may be mapped to the ticket. This mapping allows the customer-facing agent to loop the appropriate internal agent to resolve the issue associated with the ticket.

Below is a detailed description of the modules shown in FIG. 3.

In some embodiments, database 304 may include multiple storage databases, such as status database 304_{A}, groups database304_{B}, agent database 304_{C}, and tickets database 304_{D} to name a few. For example, status database 304_{A} may store a status table. This status table includes a list of statuses, such as transition states, in the helpdesk along with flags to indicate applicability for shared ownership.

Groups database 304_{B} may include a list of groups in the helpdesk along with the groups' applicability to be mapped to a status. Agent database 304_{C} may include a list of agents in the helpdesk, the agents' properties, and the group(s) that the agents the belong to. Tickets database 304_{D} include tickets in the helpdesk along with the properties of the tickets. These properties may include current transition state (status), the agent(s) working on the ticket, and the group(s) that these agents belong to.

Mapping and assignments module 306 may include a status group manager module 308, tickets module 314, and a notifications module 316. Status group manager module 308 includes a status group mapper 310 and a group agent mapper 312, and stores and provides correlation details between statuses, groups, and agents as configured by the administrator. Status group mapper 310 may map the status of a ticket to a group that can be assigned or labeled as an “internal group” within the ticket.

Groups may include a collection of agents, for example. Status group mapper 310 may allow for the assignment of a group as an internal group on the ticket, after checking if the status of the ticket allows the assignment. For example, when the status is set to “open”, a group cannot be assigned as the internal group. This is because the “open” status does not include any mapping to a particular internal group. However, when the status is set to a custom status, such as “Waiting on supplies team”, mapping, i.e., assignment of the group, is allowed. This is because the admin has preconfigured the particular custom status to a particular internal group. For this example, the admin has mapped the custom status “Waiting on supplies team” to the internal group “Supplies group”.

Upon assignment, group agent mapper 312 may provide a list of potential agents that belong to the internal group. The potential agents may be associated to the ticket as the internal agent.

Tickets modules 314 may include tickets. A ticket is a representation of an issue faced by the customer. For example, the context given in FIG. 2 is that the customer-facing (primary) agent will loop in the appropriate internal agent by selecting the appropriate status and internal group, which are validated by the status group manager 308. Notifications module 316 may alert the internal agent when a ticket is assigned by the primary agent.

Accessibility Module 318 may include an agent scoper 320 that returns information regarding the tickets, which can be accessed by the internal agent based on configured scope of the internal agent.

Results module 322 may provide a visual representation and aggregation of all the tickets that the internal agent has access to across the helpdesk's dashboard, ticket list page, and ticket details page based on information obtained from the other modules.

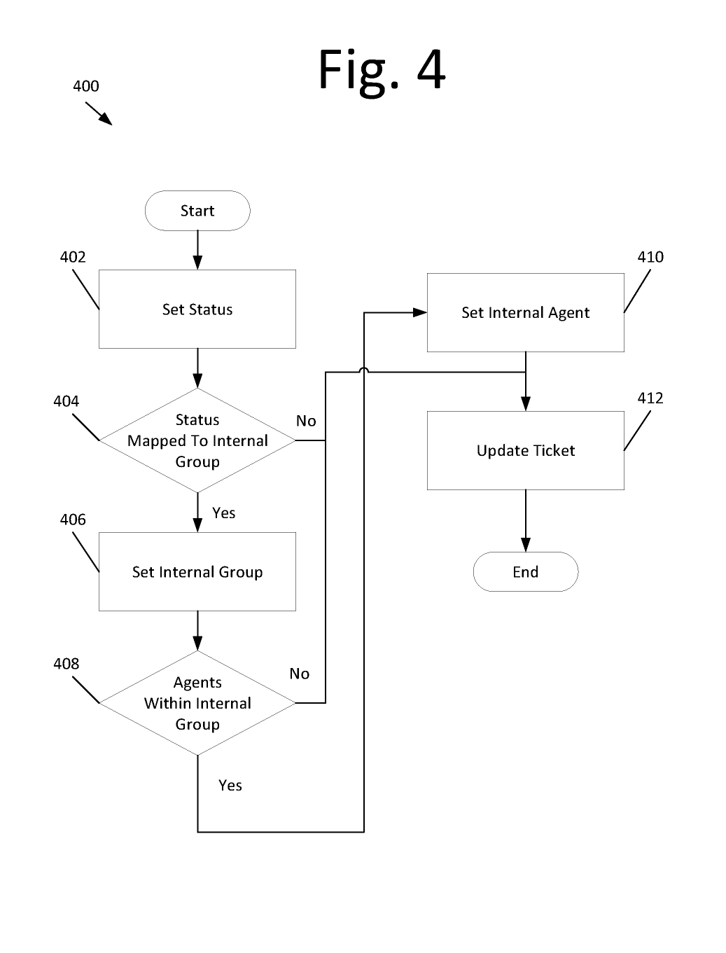

FIG. 4 is a flow diagram 400 illustrating a process for sharing ownership of a ticket, according to an embodiment of the present invention. In some embodiments, process 400 may begin at 402 with setting a ticket status to a predefined status. For example, the ticket status is changed from an “open” status to another predefined status, since “open” status may not permit sharing ownership of a ticket. The predefined status is initially created by the administrator, for example, allowing the customer-facing agent to select the status that is most applicable to the situation. At 404, a check is performed to see if the set ticket status is mapped to an internal group. If the ticket status is not mapped to an internal group, then at 412, the ticket is updated, and the process ends. In other words, the assignment process or workflow terminates at step 412, after the internal agent is assigned. This allows for the internal agent to respond to the customer-facing agent and cycle continues as demonstrated in FIG. 2, which is discussed above.

Otherwise, at 406, an internal group is set (or selected) from the list of available internal groups. The selection of the internal group is dependent on the ticket status. For example, if there are 10 different internal groups, then each internal group may be mapped to a different ticket status. Thus, the internal groups that are mapped to the selected ticket status are shown to the customer-facing agent or automatically selected by the server. At 408, a check is performed to see if an agent is available within the internal group. If an agent is not available, the ticket is updated at 412, and the process ends. Otherwise, at 410, an agent is selected from a list of available agents within the internal group, and at 412, the ticket is updated.

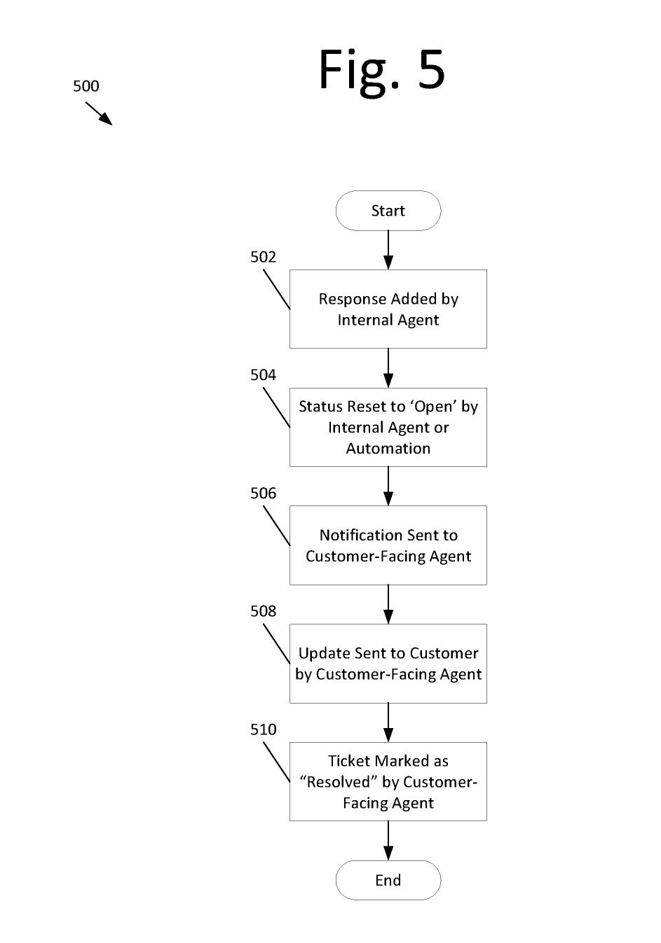

FIG. 5 is a flow diagram 500 illustrating a process for updating the ticket, according to an embodiment of the present invention. In this embodiment, the process begins at 502 with adding a response to the ticket after the internal agent evaluates the ticket. The response includes the internal agent's opinion, result, etc. At 504, the status of the ticket is reset to default, i.e., “open”. The resetting of the ticket changes the shared ownership between the customer-facing agent and the internal agent to only the customer-facing agent. In some embodiments, the ticket status may automatically be reset to default as soon as the internal agent submits his or her status. At 506, a notification is sent to the customer-facing agent notifying that the ticket status has been updated. At 508, in response, the customer-facing agent notifies the customer of the update to the ticket, and at 510, the ticket is marked as resolved by the customer-facing agent.

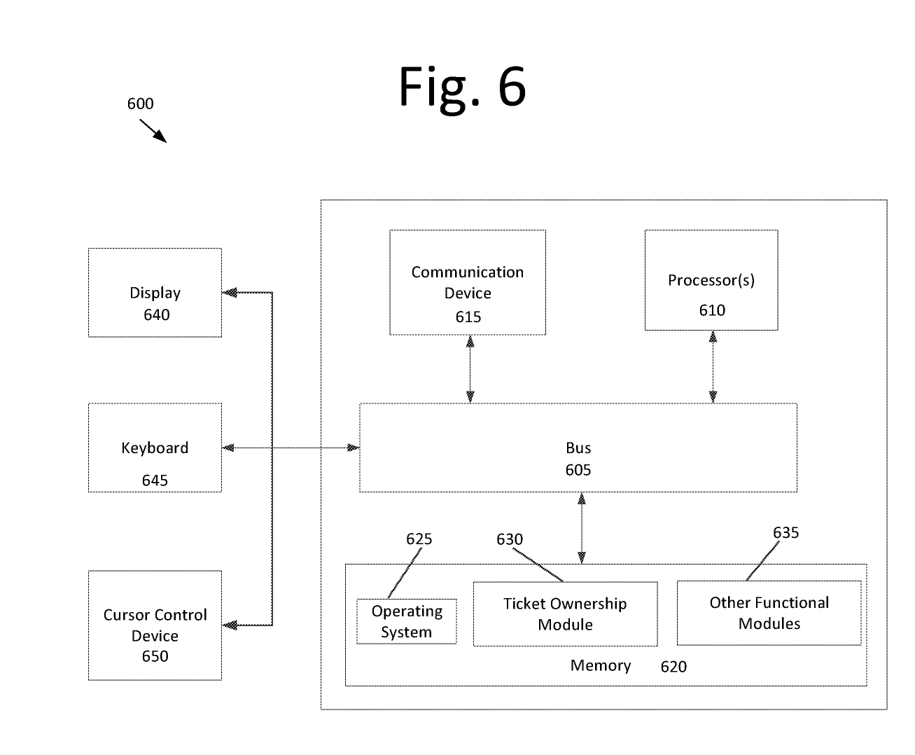

FIG. 6 is a block diagram illustrating a computing system 600 allowing a customer-facing agent to assigning the ticket improving ticket status visibility, according to one embodiment of the present invention. Computing system 600 may include a bus 605 or other communication mechanism configured to communicate information, and at least one processor 610, coupled to bus 605, configured to process information. At least one processor 610 can be any type of general or specific purpose processor. Computing system 600 may also include memory 620 configured to store information and instructions to be executed by at least one processor 610. Memory 620 can be comprised of any combination of random access memory (“RAM”), read only memory (“ROM”), static storage such as a magnetic or optical disk, or any other type of computer readable medium. Computing system 600 may also include a communication device 615, such as a network interface card, configured to provide access to a network.

The computer readable medium may be any available media that can be accessed by at least one processor 610. The computer readable medium may include both volatile and nonvolatile medium, removable and non-removable media, and communication media. The communication media may include computer readable instructions, data structures, program modules, or other data and may include any information delivery media.

At least one processor 610 can also be coupled via bus 605 to a display 640, such as a Liquid Crystal Display (“LCD”). Display 640 may display information to the customer-facing agent, such as ticket status. A keyboard 645 and a cursor control unit 650, such as a computer mouse, may also be coupled to bus 605 to enable the user to interface with computing system 600.

According to one embodiment, memory 620 may store software modules that may provide functionality when executed by at least one processor 610. The modules can include an operating system 625 and a ticket ownership module 630, as well as other functional modules 635. Operating system 625 may provide operating system functionality for computing system 600. Because computing system 600 may be part of a larger system, computing system 600 may include one or more additional functional modules 635 to include the additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process shown in FIG. 4 may be performed, in part, by a computer program, encoding instructions for a nonlinear adaptive processor to cause at least the process described in FIG. 4 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data. The computer program may include encoded instructions for controlling the nonlinear adaptive processor to implement the process described in FIG. 4, which may also be stored on the computer readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

Some embodiments generally pertain to sharing ownership of a ticket between the customer-facing agent and one or more internal agents. By sharing ownership, the aforementioned problems are resolved by allowing internal agents from different groups sharing ownership of the ticket and collaborating together to resolve the query raised in the ticket. This eliminates the need for a customer-facing agent needing to reassign a ticket, since the ticket is now visible to the customer-facing agent, who is ultimately responsible for resolving the ticket.

Other benefits that are realized by sharing tickets include improving visibility of the ticket and granting the customer-facing agent access to the ticket at all times. Also, depending on the type of resolution required, the customer-facing agent can share the ticket for resolution with an internal agent, whose inputs are required for resolving the ticket's query.

Further, since there is no duplicity of tickets (by creating separate tasks as in parent-child ticketing system), there is only one service level agreement (“SLA”). In general, among other things, the SLA provides for the response and resolution time of the service provider. Because each ticket has its own response and resolution time, if there are different tickets created based on different tasks for the same issue, each of those tickets would have their own respective response and resolution times. This would make things difficult for the customer-facing agent if the internal agents, who are required to provide their inputs, have a response and resolution time different from that of the customer-facing agent. Thus, in certain embodiments, the internal agent is also required to follow the same SLA as the customer-facing agent. This means that the customer-facing agent has control over the ticket and has control over the SLAs for the ticket.

It should be appreciated that by sharing ticket ownership, collaboration on ongoing issues or matters becomes easy with ease of access and viewability of ticket and its status. Therefore, a customer-facing agent always has information about the status of the ticket and access to the ticket. He or she can respond to any follow-up from the customer. The workflow for each shared ticket may be different and may be configured based on individual use cases.

It should be appreciated that in some embodiments that the system is set up with all stakeholders as agents. The agents are categorized into or mapped to groups relevant to their function. These are the customer-facing agents and customer-facing groups. To implement the shared ownership feature, the ticketing system may include fields, such as internal group and internal agents. The groups and agents in these internal fields may be a replication of the primary groups and primary agents. Depending on the function that would be required to resolve the ticket, the customer-facing group/agent and the internal group/agent may vary. The internal agents have the same privileges as the customer-facing agents in certain embodiments. This means that the internal agents can characterize the ticket as “open”, “closed”, “pending”, “resolved”, “awaiting response from <insert internal team's name>”, etc.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented process for improving tracking and visibility of a ticket, comprising:
changing a status of a ticket, allowing ownership of the ticket to be shared with an internal agent;
depending on the changed status, selecting an internal group mapped to the ticket from a list of available internal groups;
selecting an available internal agent from a list of available agents within the internal group; and
updating the ticket such that ownership of the ticket is shared between the customer-facing agent and the internal agent.

2. The computer-implemented process of claim 1, wherein the status is mapped to the internal group, allowing the internal agent to be selected for shared ownership of the ticket.

3. The computer-implemented process of claim 1, further comprising:
determining if the changed ticket status is mapped to an internal group.

4. The computer-implemented process of claim 1, further comprising:
determining if an internal agent from the internal group is available for associating the internal agent to the ticket.

5. The computer-implemented process of claim 1, wherein the customer-facing agent remains the primary agent and the internal agent remains the secondary agent.

6. The computer-implemented process of claim 1, further comprising:
receiving a response from the internal agent, the response is added to the ticket by the internal agent; and
resetting the status of the ticket to disassociate the internal agent from the ticket.

7. The computer-implemented process of claim 6, wherein the resetting of the status changes ownership of the ticket from the customer-facing agent and the internal agent to the customer-facing agent.

8. The computer-implemented process of claim 1, further comprising:
receiving a response from the internal agent, the response is added to the ticket by the internal agent; and
changing the status of the ticket to disassociate the internal agent from the ticket and associate a new internal agent to the ticket to further process the ticket.

9. The computer-implemented process of claim 8, wherein the changing of the status changes ownership of the ticket from the customer-facing agent and the internal agent to the customer-facing agent and the new internal agent.

10. The computer-implemented process of claim 5, further comprising:
transmitting a status update from a consumer-facing agent to a consumer associated with the ticket, notifying the consumer of the response from the internal agent; and
marking the ticket as resolved.

11. An apparatus for improving tracking and visibility of a ticket, comprising:
at least one processor; and
memory comprising a set of instructions, wherein
the set of instructions, with the at least one processor, are configured to cause the apparatus to
change a status of a ticket, allowing ownership of the ticket to be shared with an internal agent;
depending on the changed status, select an internal group mapped to the ticket from a list of available internal groups;
select an available internal agent from a list of available agents within the internal group; and
update the ticket such that ownership of the ticket is shared between the customer-facing agent and the internal agent.

12. The apparatus of claim 11, wherein the status is mapped to the internal group, allowing the internal agent to be selected for shared ownership of the ticket.

13. The apparatus of claim 11, wherein the set of instructions, with the at least one processor, are further configured to cause the apparatus to
determine if the changed ticket status is mapped to an internal group.

14. The apparatus of claim 11, wherein the set of instructions, with the at least one processor, are further configured to cause the apparatus to
determine if an internal agent from the internal group is available for associating the internal agent to the ticket.

15. The apparatus of claim 11, wherein the customer-facing agent remains the primary agent and the internal agent remains the secondary agent.

16. The apparatus of claim 11, wherein the set of instructions, with the at least one processor, are further configured to cause the apparatus to
receive a response from the internal agent, the response is added to the ticket by the internal agent; and
reset the status of the ticket to disassociate the internal agent from the ticket.

17. The apparatus of claim 16, wherein the set of instructions, with the at least one processor, are further configured to cause the apparatus to change ownership of the ticket from the customer-facing agent and the internal agent to the customer-facing agent.

18. The apparatus of claim 11, wherein the set of instructions, with the at least one processor, are further configured to cause the apparatus to
receive a response from the internal agent, the response is added to the ticket by the internal agent; and
change the status of the ticket to disassociate the internal agent from the ticket and associate a new internal agent to the ticket to further process the ticket.

19. The apparatus of claim 18, wherein the set of instructions, with the at least one processor, are further configured to cause the apparatus to change ownership of the ticket from the customer-facing agent and the internal agent to the customer-facing agent and the new internal agent.

20. The apparatus of claim 15, wherein the set of instructions, with the at least one processor, are further configured to cause the apparatus to
transmit a status update from a consumer-facing agent to a consumer associated with the ticket, notifying the consumer of the response from the internal agent; and
mark the ticket as resolved.
